(19) United States
(12) Patent Application Publication
(10) Pub. No.: US 2007/0074163 A1
(43) Pub. Date: Mar. 29, 2007

(54) Recording of scheduled broadcast in upnp

(75) Inventors: Jozef Pieter Van Gassel, Eindhoven (NL); Hong R. Li, Eindhoven (NL); Adrianus Johannes Maria Denissen, Eindhoven (NL); Adolf Proidl, Eindhoven (NL); Gerhardus Engbertus Mekenkamp, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkljke Philips Electronics N.V., BA Eindhoven (NL)

(21) Appl. No.: 10/577,099

(22) PCT Filed: Oct. 18, 2004
(86) PCT No.: PCT/IB04/52128

§ 371 Date: Apr. 25, 2006

(51) Int. Cl. G06F 9/44

(52) U.S. Cl. 717/120; 717/162

(57) ABSTRACT

A method is provided for enabling to establish a connection between multiple UpnP-compliant resources, wherein each of the resources has a respective ConnectionManager service. The method comprises configuring the respective ConnectionManager services so to enable a UpnP Control Point to use the respective services for negotiating the connection between the respective resources to be established at a time determined in advance.

### FIELD OF THE INVENTION

The invention relates to, among other things, a method of enabling to establish a connection between multiple UPnP-compliant resources, a UPnP compliant device with a ConnectionManager service, and control software for enabling to establish a connection between multiple UPnP-compliant resources.

### BACKGROUND ART

Universal Plug and Play (UPnP) is an industry-wide ongoing development for an open network architecture that is designed to enable simple, ad hoc communication among distributed devices and software applications from multiple vendors. UPnP leverages Internet technology and extends it for use in non-supervised home networks. UPnP aims at controlling home appliances, including home automation, audio/video, printers, smart phones, etc. UPnP distinguishes between Control Points (CPs) and controlled devices (CDs). CPs comprise, e.g., browsers running on PCs, wireless pads, etc., that enable a user to access the functionality provided by controlled devices.

UPnP defines protocols for discovery and control of devices by CPs. UPnP does not define a streaming mechanism for use by AudioVideo devices. Some of the discovery and control protocols are part of the UPnP specification while others are separately standardized by the IETF (Internet Engineering Task Force).

Interaction between CPs and devices is based on the Internet protocol (IP). However, UPnP allows non-IP devices to be proxied by a software component running on IP-compliant devices. Such a component, called Controlled Device (CD) proxy, is responsible for translation and forwarding of UPnP interactions to the proxied device.

A UPnP device has a hierarchy of sub-devices with at the lowest level services. Both devices and services have standardized types. A device type determines the sub-devices or services that it is allowed to contain. A service type defines actions and state variables that a service is allowed to contain. State variables model the state of the device, and a CP can invoke actions in order to change that state. The description of the state variables and the actions is called the SCP (Service Control Protocol). A UPnP device provides a description of itself in the form of an XML document. This document contains, among other things, the service types that it supports. Optionally, a device may have a presentation server for direct UI control by a CP.

UPnP relies currently on AutoIP, which provides a means for an IP device to get a unique address in the absence of a DHCP server. UPnP defines a discovery protocol, based on UDP (User Datagram Protocol) multicast, called SSDP (Simple Service Discovery Protocol). SSDP is based on devices periodically multicasting announcements of the services that they provide. An announcement contains a URL to which service actions are to be sent: the control server. In addition to that, CPs may query the UPnP network for particular device or services types or instances.

UPnP relies on GENA (Generic Event Notification Architecture) to define a state variable subscription and change notification mechanism based on TCP.

After a CP has detected a service it wants to use (via SSDP), it controls the service by sending SCP actions to the control server URL or querying for state variables. Actions are sent using HTTP POST messages. The body of such a message is defined by the SOAP (Simple Object Access Protocol) standard. SOAP defines a remote procedure call mechanism based on XML.

The UPnP AV (audio/video) specification relates to interaction between UPnP AV devices, e.g., TV sets, video recorders, DVD players, settop boxes (STBs), PCs, etc., and the associated CPs. The UPnP AV specification defines a MediaServer device and MediaRenderer device and their services. A MediaServer (MS) on the network stores AV content and exposes it to other devices on the network. Content items are stored in a hierarchical view, similar to file folders in an electronic filing system on a PC, for example. A MediaRenderer (MR) on the network plays back or otherwise processes the AV content stored at the MSs. An MR can have implemented a Rendering Control (RC) service to provide a CP with a mechanism to control how the content is being rendered (e.g., volume, brightness, contrast, etc.).

A ConnectionManager (CM) in UPnP is a service-type that enables modeling of streaming capabilities of AV devices, and binding of those capabilities between devices. Each device that is able to send or receive a stream according to the UPnP AV device model has one instance of the CM service. This service provides a mechanism for CPs to: perform capability matching between source/server devices and sink/renderer devices; find information about currently ongoing transfers in the network; and setup and teardown connections between devices. The CM service properly abstracts different kinds of streaming mechanisms, such as HTTP-based streaming, RTSP/RTP-based and 1394-based streaming. The CM enables CPs to abstract from physical media interconnect technology when making connections.

The AV Transport (AVT) service in UPnP provides actions that allow a CP to control the flow of the content. This includes operations such as Play, Stop, Pause, Seek, etc. A CP uses the AVT to identify the content that is to be played. This is accomplished by forwarding the URI, obtained from the Content Directory Service (CDS) for the desired content and the selected protocol and format. Dependent on the protocol for transfer of the content, either the MS or the MR may provide an instance of the AVT service. If the selected protocol is a “pull” model (e.g., HTTP GET), then the MR is required to provide an instance of AVT to control the flow of the content (e.g., play, pause, seek). If the selected protocol is a “push” model, then the server must provide an instance of AVT.

### SUMMARY OF THE INVENTION

The inventors have recognized that the UPnP AV framework only allows recording of live or direct content, i.e., no provisions have been made for scheduled recordings. Hence it is practically not possible within UPnP to prepare in advance for recording a specific television program that will be broadcast sometime in the future. The inventors therefore propose an extension to the current UPnP specification by allowing scheduled recordings. This extension builds on top of the current specification by adding one vendor-specific extension and re-uses existing functionality as much as possible in the spirit of the current UPnP standard.

The basic idea is to allow for scheduled recording by means of introducing the concept of a delayed (i.e., future) connection. In UPnP, reservation of resources is taken care of by the CM service. In the current standard however, it is only possible to request an immediate connection by respective CM entities at both ends of the digital interconnect. For the purpose of scheduled recordings a new action is added to the CM, referred to as, for example, “PrepareForDelayedConnection”. This action extends the “PrepareForConnection” in the sense that it can be used for reserving resources (i.e., a tuner and a recording in this case) for a particular time slot in the future. The actual streaming of the content from the tuner (source) to the recorder (sink) will take place in the time slot limited by the “ScheduledStartTime” and the “ScheduledStopTime”. This information can easily be obtained from the CDS of the tuner (source) device.

More specifically, the invention relates to a method of enabling to establish a connection between multiple UPnP-compliant resources that each have a respective ConnectionManager service. The method comprises configuring the respective ConnectionManager services so as to enable a UPnP Control Point to use the respective services for negotiating the connection between the respective resources to be established at a time determined in advance, and to be maintained for a particular period of time. This embodiment of the invention is relevant to, e.g., a service provider or another party upstream of the end user in a delivery chain of electronic content information, assisting the end-user at setting up his/her UPnP network.

The invention also relates to a method of establishing a connection between multiple UPnP-compliant resources that each have a respective ConnectionManager service. The method comprises using the respective ConnectionManager services that have been configured so as to enable a UPnP Control Point to use the respective services for negotiating the connection between the respective resources to be established at a time determined in advance, and to be maintained for a particular period of time. This embodiment is relevant to, e.g., the end-user in a context of operational use of the UPnP home network.

The resources comprise, e.g., a tuner for tuning to a broadcast channel (e.g., the Internet, radio or TV) and a recorder for recording a broadcast.

The invention also relates to a UPnP compliant device that has a ConnectionManager service configured so as to enable a UPnP Control Point to use the service for negotiating with another ConnectionManager service a connection with another device to be established at a time determined in advance and to be maintained for a particular period of time. The device comprises, e.g., a tuner for tuning to a broadcast channel and/or a recorder for recording content information.

The invention also relates to control software for enabling to establish a connection between multiple UPnP-compliant resources. Each of the resources has a respective ConnectionManager service. The software is operative to configure the respective ConnectionManager services so as to enable a UPnP Control Point to use the respective services for negotiating the connection between the respective resources to be established at a time determined in advance and to be maintained for a particular period of time.

### BRIEF DESCRIPTION OF THE DRAWING

The invention is explained in further detail, by way of example and with reference to the accompanying drawing wherein:

FIG. 1 is a block diagram of a UPnP control system in the invention;

FIG. 2 is a table clarifying the arguments of the new extension to a UPnP action;

FIG. 3 is an example of hierarchical structure of a CDS of a tuner device;

FIG. 4 gives the sequence of interactions between entities in the system of FIG. 1; and

FIGS. 5-11 are examples of pseudo-code relating to actions in the system of FIG. 1.

Throughout the figures, same reference numerals indicate similar or corresponding features.

### DETAILED EMBODIMENTS

Below is explained in detail how the known UPnP A/V network architecture can be extended to support a scheduled (or programmed) recording of audio and/or video content from a future broadcast.

First, the following high-level network entities are introduced.

A tuner device (i.e., the source device) is modeled as an UPnP MS device exposing the channels and an optionally available Electronic Programming Guide (EPG) via its CDS. The CM service will be used to manage the tuner resources, and the AVT service will be used to push the broadcast content onto the network using, e.g., RTP.

A rendering device is modeled as an UPnP MR that is used for (remote) rendering of a live broadcast or a recording. This is a standard UPnP MR with a CM service, and optionally an AVT and RC service.

A recording device is modeled as a UPnP MS. The recorder device serves as a sink, similarly to an MR, for the content streamed over the network.

A CP is used to schedule the recording of a broadcast and to control the playback of the recording to an MR afterwards.

Note that these are all logical entities. Two or more of these entities can be combined into a single physical device. For instance, a networked A/V Recorder will most likely contain an MS to expose the tuner channels and the locally stored content to the network. In addition, it might contain an MR to playback the recorded content or live broadcasts to an (analog) output of a connected display. Furthermore, it may also contain a CP for control of the MS and the MR.

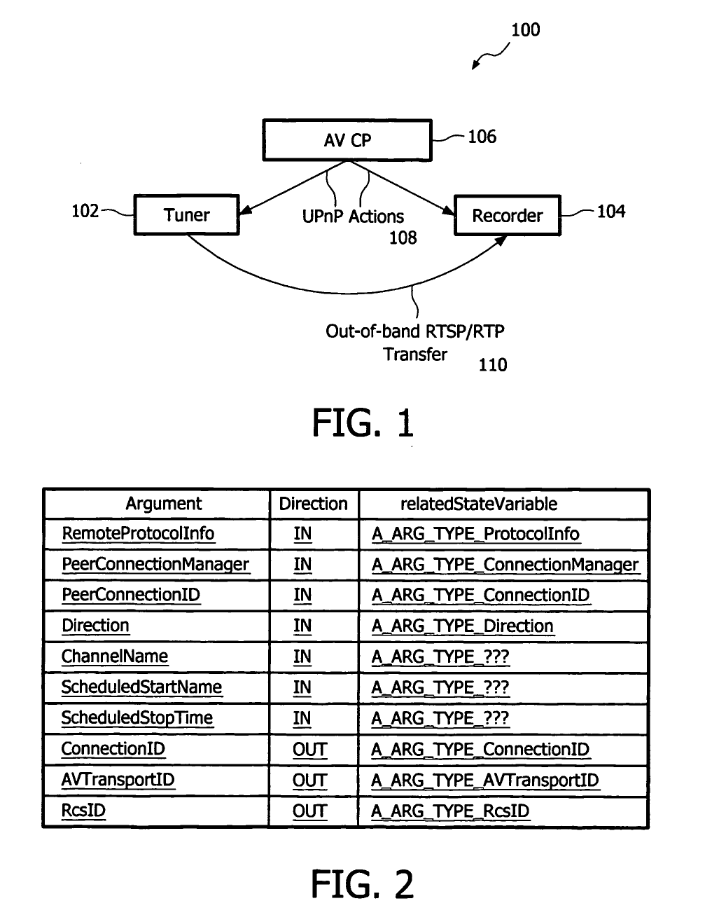

FIG. 1 is a block diagram of a system 100 in the invention that illustrates the cooperation of a tuner 102, a recorder 104 and a CP 106 in a UPnP network. CP 106 controls tuner 102 and recorder 104 through invoking UPnP actions 108. Recorder 104 receives the content from tuner 102 using an appropriate transfer protocol 110, e.g., RTSP/RTP

In order for system 100 to work with scheduled broadcasts, the following issues are to be solved:

Resource (i.e., Connection) Scheduling and Reservation;

Mapping an EPG onto a CDS; and

Streaming the (MPEG-2) Transport Streams in the network.

As to the scheduling of resources on either side of the network interconnect, this can be implemented using a simple extension to the UPnP CM service. For this purpose, the inventors have introduced the concept of a delayed or future connection. This enables CMs to reserve their respective resources. The source device, here tuner 102, reserves the tuner channels, and recorder 104 reserves bandwidth to its storage. Note that the concept of a delayed connection maintains the nature of an ad-hoc network. A central control entity is not required.

Under the known specs, a CM service only allows the setting up of connections for immediate use. An extension of the “PrepareForConnection” action command is needed for setting up future connections in order to make scheduled recordings. For this purpose, a new, possibly vendor-specific, action “PrepareForDelayedConnection” is added to the CM.

FIG. 2 is a table listing the arguments of the “PrepareForDelayedConnection” action, additional arguments according to the invention are given in bold characters.

The “PrepareForDelayedConnection” function does not automatically re-adjust to delayed broadcasts, i.e., broadcasts whose start and/or stop times are changed after recorder 104 has been programmed. This situation can be dealt with by having a built-in CP (not shown) in recorder 104 subscribe to the CDS (not shown) that contains the channel to be recorded. When the scheduled time changes, an event will be triggered at the CP that can be used to invoke appropriate actions. The scheduled start/stop times of the connection reserved can be updated by re-negotiating a new (delayed) connection between the MS of tuner 102 and the MS of recorder 104. Canceling of a scheduled recording is simply a matter of invoking a “ConnectionComplete” action at both CMs at opposite sides of the connection. For convenience, additional actions can be added to carry out this scenario.

As to the mapping of the EPG, a preferred embodiment to expose the EPG information to the network uses the CDS. A special “upnp:class” called “object.item.videoItem.videoBroadcast” has been defined in the original UPnP specification as “a continuous stream of video that is interpreted as a broadcast”. This UPnP class has a special “channelNr” property and an “icon” property that are defined to indicate the channel of tuner 102 and an icon to represent the channel graphically in a user interface (not shown), respectively. This way, a standard object in the CDS can be used to tune to a specific channel of tuner 102.

The “object.item.videoItem.movie” class has properties “channelName”, “scheduledStartTime” and “scheduledStopTime”. These objects contain all the information required to make a scheduled recording. According to the specification an actual recording should be described as an “object.item.videoItem.movie”.

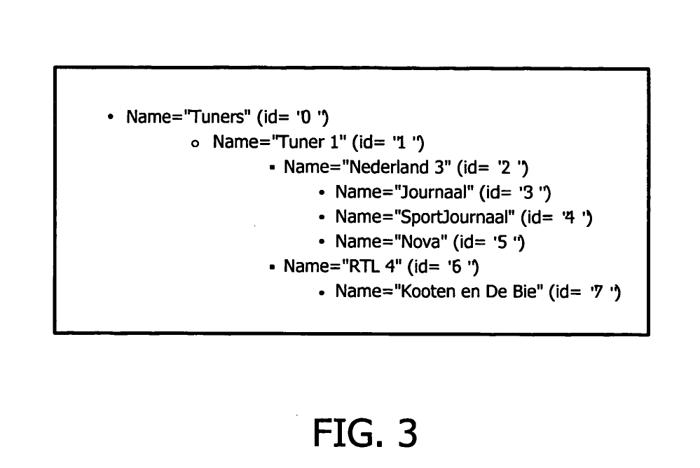

FIG. 3 is an example of the CDS structure of tuner 102 (with a single tuner and two channels). Note that an “item.videoItem.videoBroadcast” object is not a container type. Therefore, the hierarchy in the example of FIG. 3 might, strictly speaking, not be compliant with the standard, although from the operational or technical point of view there is no problem.

As to the transport streams, the actual streaming of the AV content is taking place out of band. Hence, any suitable transport protocol is possible in principle. However, since all digital broadcasting is based on MPEG-2 Transport Streams and the tuners work according to the push model, it is convenient to use the RTP/RTSP Internet streaming protocols for this purpose. Setting up RTP streams using UPnP is covered by the UPnP AV specifications, and needs not be discussed here in further detail.

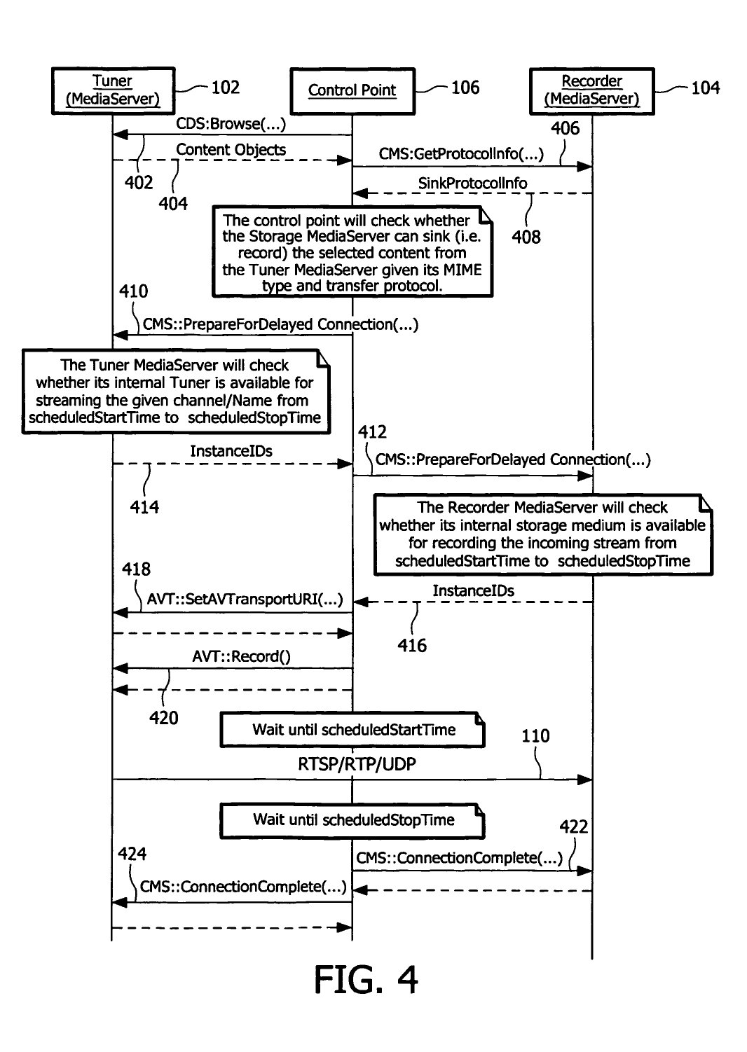

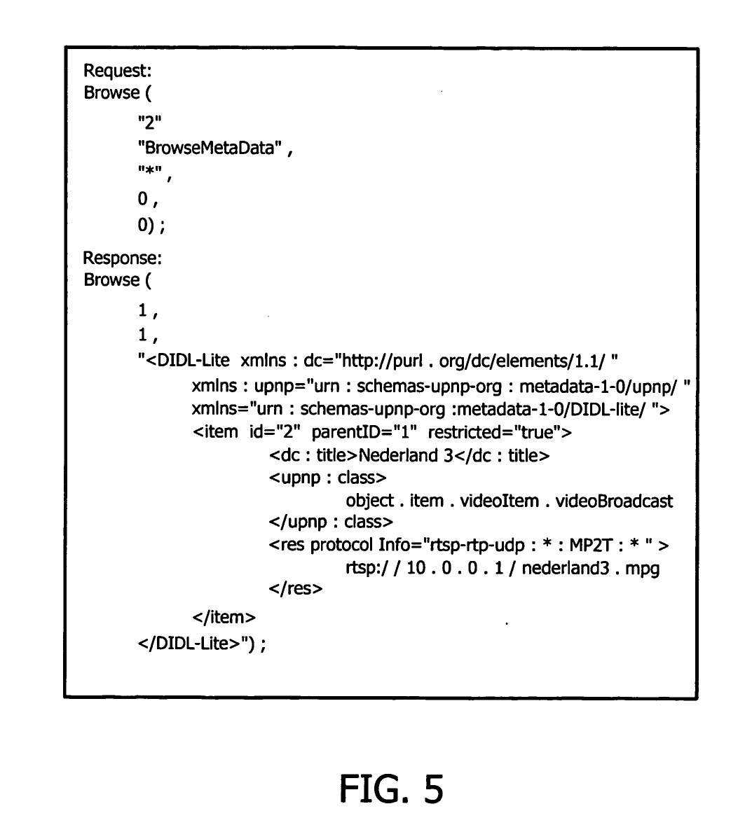

FIG. 4 is a diagram illustrating a sequence 400 of interactions 402-420 between the entities of system 100 in a scenario to make a scheduled recording. FIGS. 5-11 illustrate in pseudo-code the various actions invoked on network 100 in this scenario.

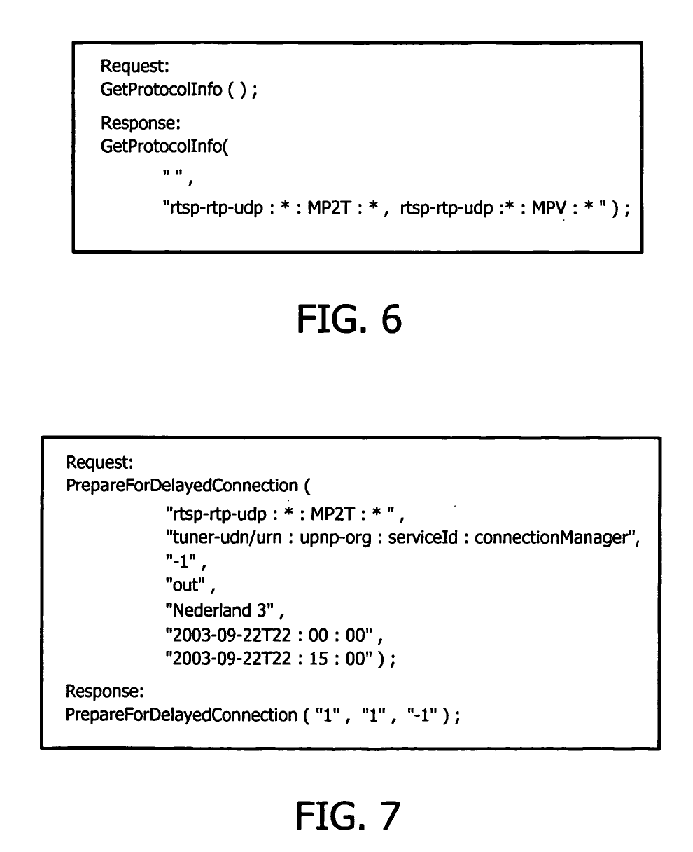

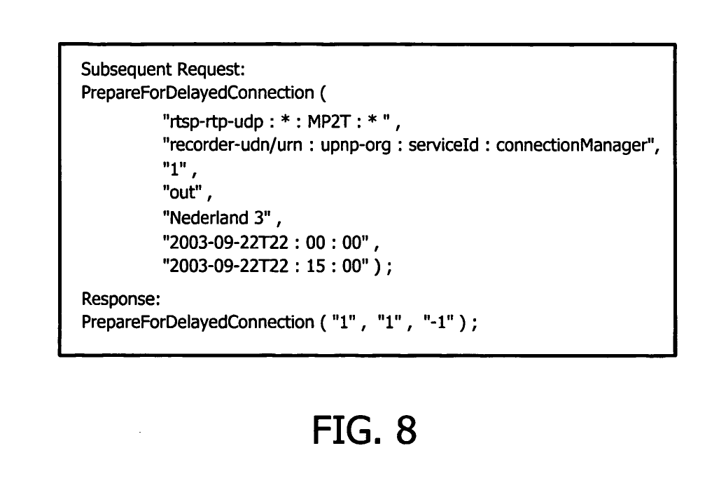

First, using the Discovery mechanism in UPnP, CP 106 discovers the relevant MSs and/or MRs, e.g., tuner 102 and recorder 104, on network 100. Next, CP 106 locates the desired content. In the example scenario, the desired content includes tuner channels and scheduled broadcast programs in the EPG. In a step 402 in FIG. 4, CP 106 locates a desired content item using the ContentDirectory::Browse( ) or ContentDirectory::Search actions of the MS of tuner 102. FIG. 5 illustrates the Browse Request and the Response. The information returned to CP 106 by Browse( )/Search( ) in a step 404 includes information about the transfer protocols and data formats supported by the MS of tuner 102. FIG. 6 illustrates in pseudo-code how the ConnectionManager::GetProtocolInfo( ) action in a step 406 causes the MS of recorder 104 to return a list to CP 106, in a step 408, of transfer protocols and data formats supported by the MS of recorder 104. These are the transfer protocols and data formats that can be used to record data at the storage medium of recorder 104. Then, the protocol/format information returned by the CDS for the desired Content Item of the MS of tuner 102 is matched against the protocol/format information returned by the MS's GetProtocolInfo( ) action of recorder 104, or vice versa. CP 106 selects a transfer protocol and data format that is supported by both the MS of tuner 102 and MS of recorder 104. In steps 410 and 412, the ConnectionManager::PrepareForDelayedConnection( ) actions initiated by CP 106 informs the MSs of tuner 102 and recorder 104 that an outgoing/incoming connection is about to be scheduled using the specified transfer protocol and data format that has been selected. FIG. 7 gives an example action invocation issued by CP 106 to schedule a recording. If one or both of the resources cannot fulfill this request, e.g., because it is not available, CP 106 is notified by a returned error message. Assume that both resources fulfill the request. Subsequently, CP 106 invokes the action on the MS of recorder 104 as indicated in FIG. 8. The InstanceIDs are used in conjunction with the device's AVT service (i.e., the device returning the AVT InstanceID in steps 414 and 416) to control the flow of the content data. Invoking SetAVTransportURI 418 causes the URL to be selected that is associated with the selected source (e.g., tuner channel). The URL is here selected at tuner 102 to uniquely identify the content to be sourced to the network of system 100. Action 420 initiates the actual recording on the AVT service. Note that in this example of scheduled recording, the recording does not start until the scheduledStartTime commences. Note that conventionally, according to the original UPnP specification, the recording is started immediately.

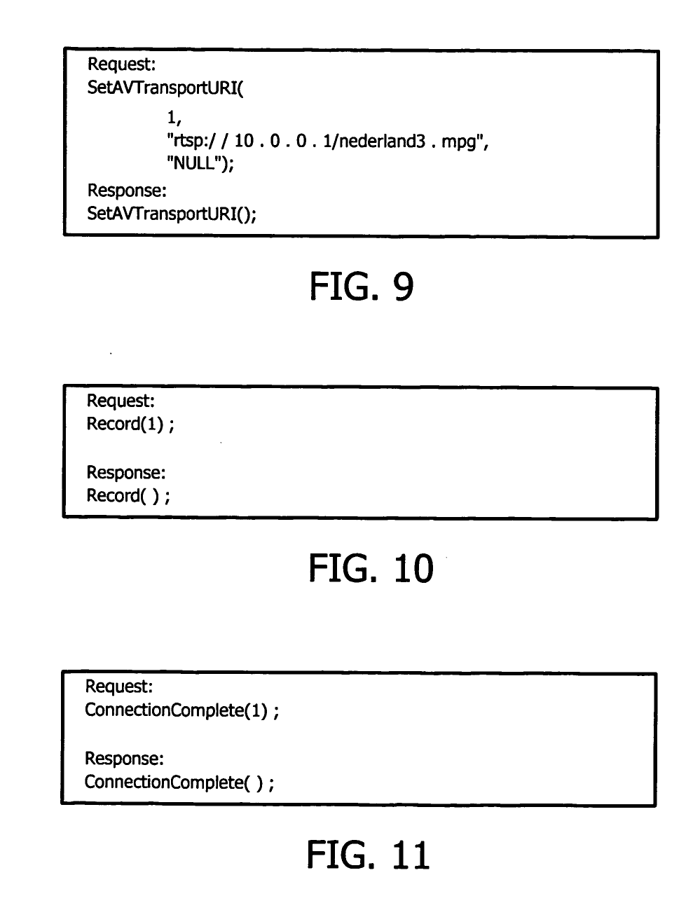

FIG. 9 illustrates that CP 106 invokes the action to identify the content item that needs to be transferred (i.e. recorded), using the AVT service, whose InstanceID is returned by either one of the MSs of tuner 102 or recorder 104. Using the AVT service, CP 106 invokes the recording action as illustrated in FIG. 10. Note that the actual recording will take place at the scheduledStartTime and will continue until the scheduledStopTime. According to the AVT service, the object of the recording will be added to the CDS of recorder 104 in a device-dependent way. This means that no explicit CreateObject( ) action invocation is required. When the recording session is terminated the MSs of tuner 102 and recorder 104 are no longer needed in the context of the session. Their respective ConnectionMgr::ConnectionComplete( ) actions are invoked in steps 422 and 424 to close the MSs connection, as illustrated in the code of FIG. 11.

Above example illustrates the concept of a delayed connection in a scenario of arranging in advance the recording of a scheduled broadcast. The concept of a delayed connection within a UPnP framework is applicable to a wide variety of scenarios wherein CMs of UPnP devices or functionalities are to set up a connection at a time determined in advance. Examples of other scenarios are discussed in U.S. Ser. No. 09/802,618 (attorney docket US 018028) filed Mar. 8, 2001 for Eugene Shteyn for ACTIVITY SCHEDULE CONTROLS PERSONALIZED ELECTRONIC CONTENT GUIDE, herein incorporated by reference and published as US Pat. App. Publ. 20020133821. This document relates to selecting electronic content information and the time slots for play-out based on the activities scheduled in the user's electronic calendar and the user's profile or declared interests. In this manner, the recording, downloading and rendering of content is automated based on the user's life style.

1. A method of enabling to establish a connection between multiple UPnP-compliant resources, wherein each of the resources has a respective ConnectionManager service, and wherein the method comprises configuring the respective ConnectionManager services so as to enable a UPnP Control Point to use the respective services for negotiating the connection between the respective resources to be established at a time determined in advance.

2. The method of claim 1, wherein the resources comprise a tuner for tuning to a broadcast channel and a recorder for recording a broadcast.

3. A method of establishing a connection between multiple UPnP-compliant resources, wherein each of the resources has a respective ConnectionManager service, and wherein the method comprises using the respective ConnectionManager services configured so as to enable a UPnP Control Point to use the respective services for negotiating the connection between the respective resources to be established at a time determined in advance.

4. The method of claim 3, wherein the resources comprise a tuner for tuning to a broadcast channel and a recorder for recording a broadcast.

5. A UPnP compliant device with a ConnectionManager service that is configured so as to enable a UPnP Control Point to use the service for negotiating with another ConnectionManager service a connection with another UPnP-compliant device to be established at a time determined in advance.

6. The device of claim 5 comprising a tuner for tuning to a broadcast channel.

7. The device of claim 5, comprising a recorder for recording content information.

8. (canceled)
